(19) United States
(12) Patent Application Publication
(10) Pub. No.: US 2008/0115663 A1
(43) Pub. Date: May 22, 2008

(54) Vibration damper with amplitude-selective damping force

(75) Inventor: Thomas Hammer, Bischofsheim (DE)

Correspondence Address: COHEN, PONTANI, LIEBERMAN & PAVANE, 551 FIFTH AVENUE, SUITE 1210, NEW YORK, NY, 10176, US

(73) Assignee: ZF Friedrichshafen AG, Friedrichshafen (DE)

(21) Appl. No.: 11/906,841

(22) Filed: Oct. 4, 2007

(30) Foreign Application Priority Data
Oct. 5, 2006 (DE) 10 2006 047 093.1

(51) Int. Cl. F16F 9/44; F16F 9/48

(52) U.S. Cl. 92/143

(57) ABSTRACT

A vibration damper including a cylinder filled with damping medium; a piston rod axially moveable in the cylinder; a piston mounted on the piston rod in the cylinder, the piston dividing the cylinder into a first working space around the piston rod and a second working space away from the piston rod; a valve opening communicating with the first working space; a valve ring on the piston rod and in the first working space, the valve ring being configured to influence an inflow into the valve opening; and a valve sleeve surrounding the piston rod. The valve ring is axially moveable in the valve sleeve.

### BACKGROUND OF THE INVENTION

1. Field of the Invention

The invention relates to a vibration damper with amplitude-selective damping force.

2. Description of the Related Art

DE 39 14 298 C1 describes a hydraulic vibration damper with a piston rod, which, together with a piston, is free to move axially back in forth in a cylinder. The piston divides the cylinder into two working spaces, one on the side of the piston which carries the piston rod and one on the side of the piston opposite the piston rod. Both of these spaces are filled with a damping medium. In the working space on the piston rod side, a valve ring is mounted with freedom to slide on the piston rod. As a function of its axial position, the valve ring controls the cross section of a valve opening. The valve ring is in frictional contact with the piston rod, so that, when the piston rod moves, the valve ring also executes axial movement. Damping medium can flow out of the piston rod-side working space until, after a defined stroke distance, the valve ring closes the valve opening.

### SUMMARY OF THE INVENTION

DE 39 14 298 C1 describes the principle of a solution. An object of the present invention is to provide a design suitable for manufacturing.

According to the invention, the object is accomplished in that a valve housing, in which the valve ring is free to move axially back and forth, is located in the piston rod-side working space.

The great advantage here is that all of the components which determine the function of the amplitude-selective damping force are located inside the valve housing, and this structural unit can simply be pushed into the cylinder, which means that no complicated changes to the cylinder are required. This structural unit can be tested on a test bench independently of the vibration damper.

In another advantageous embodiment, the valve sleeve is supported at least indirectly on a piston rod guide, which closes off the cylinder axially. In addition, the valve sleeve has a bottom part with a through-opening for the piston rod, where the bottom part has at least one connecting opening, which can be closed by an end surface of the valve ring.

To adapt the damping force characteristic within the stroke range of the amplitude-selective damping force, a pilot opening disk determines the maximum effective cross section of the valve opening. By simply replacing the pilot opening disk, adjustments to the damping force curve can be made without otherwise changing the valve sleeve.

The pilot opening disk is pretensioned between the valve sleeve and the piston rod guide.

There are various ways in which the valve opening can be designed. One of these is to provide the valve opening in the cylinder.

A highly advantageous variant consists in providing the valve opening in the piston rod guide. The valve opening is formed in the piston rod guide by a groove in the guide's end surface. This groove extends through an axial stop surface for the cylinder. The valve opening can be produced very easily, especially in the case of a piston rod guide made of sintered material, and can be accomplished with almost complete cost neutrality.

Another measure for retaining the simplest possible cylinder is to design the valve sleeve so that it defines an axial channel, which allows damping medium to flow into a working chamber, which is located between the valve ring and the piston rod guide and which is bounded by the valve sleeve.

The axial channel is formed by reducing at least part of the outside diameter of the valve sleeve. The outside diameter can be reduced around the entire circumference, or it can be reduced only in the sense that at least a groove is formed.

To minimize leakage between the valve sleeve and the cylinder, the valve sleeve is sealed off against the inside wall of the cylinder by at least one seal.

The radial pretension of the seal is selected in such a way that the seal secures the axial position of the valve sleeve. One simply uses the frictional force between the seal and the inside wall of the cylinder.

According to an advantageous embodiment, the valve sleeve has at least one flow connection between the two sections of the working chamber divided by the valve ring, i.e., the chamber defined by the piston rod and the inside wall of the valve sleeve. The valve ring should be actuated by the piston rod purely as a function of distance the piston rod travels, i.e., it should be as free as possible of the pressures prevailing in the two sections of the working chamber.

For example, the flow connection can be formed by a longitudinal groove in the inside wall of the valve sleeve, as a result of which the valve ring can have a uniform circular shape.

The valve ring comprises a friction ring and a sealing ring, which is free to move radially with respect to the friction ring and which influences the inflow into the valve opening. This allows radial offsets of the valve sleeve and the cylinder relative to the piston rod to be compensated.

The sealing ring surrounds the outside of the friction ring and comprises a lateral wall section and a bottom part; the friction ring is supported on the inside surface of the bottom part.

Another measure for equalizing the pressures on the valve ring consists in providing a throttle opening in the working chamber between the valve ring and a cover of the valve sleeve. This throttle opening leads to the piston rod-side working space. When the piston rod moves, the damping medium thus acts on both sides of the valve ring.

The throttle opening is formed by the cover in conjunction with a throttle disk, which is pretensioned toward the valve sleeve. The distribution of the damping medium volume entering the working chambers can be adjusted by replacing the throttle disk with a different one.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is explained in greater detail below on the basis of the following description of the figures:

FIG. 1 shows a vibration damper with a valve opening in the cylinder; and

FIG. 2 shows a vibration damper with a valve opening in the piston rod guide.

### DETAILED DESCRIPTION OF THE PREFERRED EMBODIMENTS

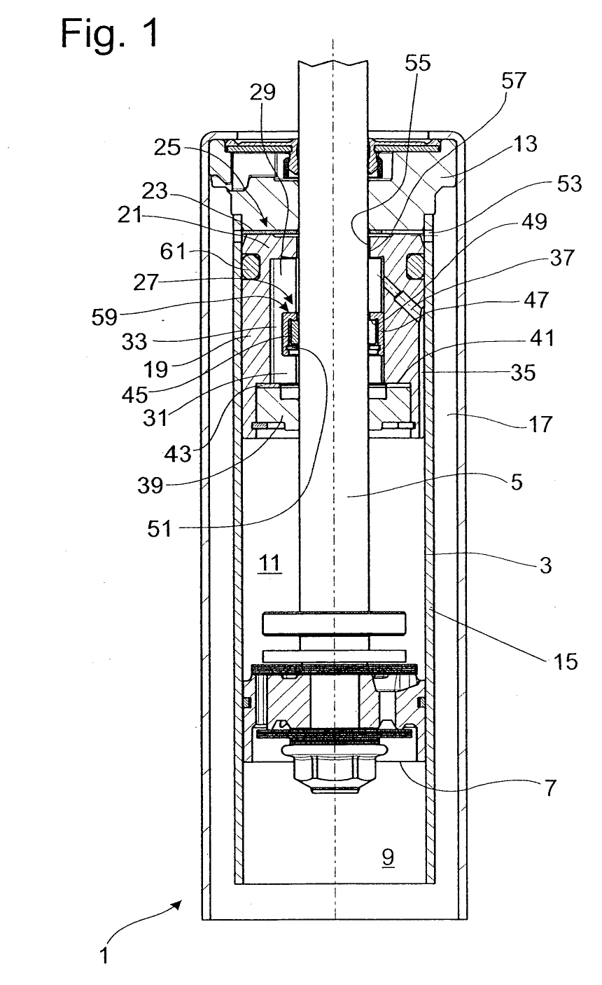

FIG. 1 shows part of a vibration damper 1, which has a cylinder 3, in which a piston rod 5 with a piston 7 is supported so that it is free to move axially back and forth. The piston 7 divides the cylinder 3 into a working space 9 on the side of the piston opposite the piston rod 9 and a working space 11 on the side of the piston with the piston rod. A piston rod guide 13 seals off the piston rod-side working space 11 of the cylinder 3.

The cylinder 3 is enclosed by a container tube 15, where a compensating space 17 defined by the container tube 15 compensates for the volume of the inward and outward-traveling piston rod 5.

In the piston rod-side working space 11, a valve sleeve 19 is provided, the bottom part 21 of which rests by way of a throttle disk or pilot opening disk 23 indirectly on an end surface 25 of the piston rod guide 13 facing the working space 11. Inside the valve sleeve 19, a valve ring 27 is supported with freedom to slide axially along the lateral surface of the piston rod 5, so that two working sections 29, 31 are present in the valve sleeve. Between the two working sections 29, 31 there is a flow connection 33, which is formed by, for example, a longitudinal groove in the inside wall of the valve sleeve 13.

The valve sleeve 19 is guided radially by the inside wall of the cylinder 3. An outside diameter reduction in the form of at least one axial groove 35 forms an axial channel between the piston rod-side working space 11 and the working section 29 located between the valve ring 27 and the bottom part 21 inside the valve sleeve 19, at least one connecting channel 37 also being provided between the axial channel 35 and the working section 29. It is also possible to provide several axial channels. The working section 31 bounded by a cover 39 of the valve sleeve 19 and the valve sleeve 19 has a throttle opening 41 leading to the piston rod-side working space 11. The throttle opening 41 is formed by at least one throttle disk 43 located between the cover 39 and the valve sleeve 19.

The valve ring 27 includes a friction ring 45, which slides on the piston rod 5, and a sealing ring 47 with a lateral surface which surrounds the friction ring 45, where the sealing ring 47 is free to move radially within certain limits with respect to the friction ring 45. The friction ring 45 can support itself axially on the bottom part 49 of the sealing ring 47 and a lock washer 51.

In this variant of the invention, a valve opening 53 is provided in the cylinder. This opening 53 is connected to the working sections 29, 31 of the valve sleeve 19 by the pilot opening disk 23 and a connecting channel 55 in the bottom part 21 of the valve sleeve 19. The connecting channel 55 is formed by a through-opening 57 in the bottom part 21, through which the piston rod 5 also passes, where the upper end surface 59 of the valve ring 27 is able to close off the through-opening 57.

When the piston rod 5 moves outward, the valve ring 27 slides inside the valve sleeve 19 synchronously with the piston rod 5 as a result of friction. Damping medium is thus displaced from the working space 11 on the piston rod side, through the axial channel 35 between the valve sleeve 19 and the inside wall of the cylinder 3, and into the valve sleeve 19. A smaller volume flows via the cover 39 and the throttle opening 41 of the throttle disk 43 into the lower working section 31, but the pressure always equalizes because of the axial channel 33 between the working sections 29, 31. The damping force generated during the outward travel of the piston rod 5 is determined by the throttle disk 23 located between the bottom part 21 and the piston rod guide 13.

After a certain stroke length of the piston rod 5, the valve ring 27 comes to rest on the inside surface of the bottom part 21 of the valve sleeve 19 and thus seals off both the connecting channel 55 to the valve opening 53 and the connecting channel 37. The axial channel 35 between the cylinder wall and the valve sleeve 19 is closed off at the end by a seal 61, so that the damping medium present there cannot flow any farther. In addition, the seal 61 also serves to hold the valve sleeve 19 axially in place inside the cylinder 3. From this stroke position on, the damping force is determined by damping valves, e.g., in the piston 7. The volume in the working chambers 29, 31 of the valve sleeve 19 is compressed during the outward travel of the piston rod via the throttle opening 41, so that an additional hydraulic closing force acts on the valve ring 27.

When the piston rod 5 travels inward, the valve ring 19 is lifted from the bottom part 21 as a result of the frictional force between the friction ring 45 and the piston rod 5 and releases the connecting channel 55 again.

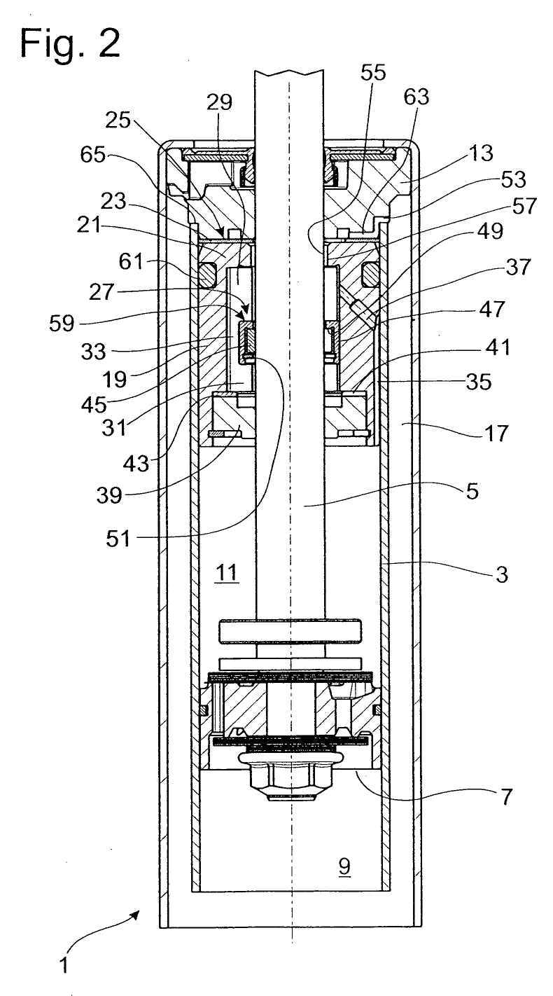

FIG. 2 is identical to FIG. 1 with respect to the valve sleeve 19 and the components present in it. The difference is that the valve opening 53 is formed here by a groove 63 in the end surface of the piston rod guide 13. This groove extends through an axial stop surface 65 for the cylinder 15 and thus allows damping medium to flow around the end of the cylinder 15.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A vibration damper comprising:
a cylinder filled with damping medium;
a piston rod axially moveable in the cylinder;
a piston mounted on the piston rod in the cylinder, the piston dividing the cylinder into a first working space around the piston rod and a second working space on a side of the piston facing away from the piston rod;
a valve opening communicating with the first working space;
a valve ring on the piston rod and in the first working space, the valve ring being configured to influence an inflow of the damping medium from the first working space into the valve opening; and
a valve sleeve surrounding the piston rod,
wherein the valve ring is axially moveable in the valve sleeve.

2. The vibration damper of claim 1, further comprising a piston rod guide which closes off the cylinder axially, the valve sleeve being supported by the piston rod guide.

3. The vibration damper of claim 1, wherein the valve sleeve comprises a bottom part having a through opening for the piston rod, the bottom part further having a connecting opening communicating with the valve opening and closable by the valve ring.

4. The vibration damper of claim 2, further comprising a pilot opening disk communicating with the valve opening and defining a maximum effective cross section of the valve opening.

5. The vibration damper of claim 4, wherein the pilot opening disk is pre-tensioned between the valve sleeve and the piston rod guide.

6. The vibration damper of claim 1, wherein the valve opening is formed in the cylinder.

7. The vibration damper of claim 2, wherein the valve opening is formed in the piston rod guide.

8. The vibration damper of claim 7, wherein the cylinder comprises an axial stop surface, the piston rod guide having an end surface facing the valve sleeve, and a groove in the end surface and extending through the axial stop surface, the valve opening comprising the groove.

9. The vibration damper of claim 2, wherein a working section is radially bounded by the valve sleeve and the piston rod and disposed axially between the piston rod guide and the valve ring, the valve sleeve having an axial channel communicating with the working section.

10. The vibration damper of claim 9, wherein the valve sleeve has an axial portion of a reduced outside diameter, which axial portion forms the axial channel.

11. The vibration damper of claim 1, further comprising a seal between the cylinder and the valve sleeve.

12. The vibration damper of claim 11, wherein the seal is radially pretensioned so that the valve sleeve is secured axially relative to the cylinder by the seal.

13. The vibration damper of claim 1, wherein the valve sleeve and the piston rod define therebetween a working chamber, the valve ring dividing the working chamber into two working sections which are connected to each other by a flow connection defined by the valve sleeve.

14. The vibration damper of claim 13, wherein the valve sleeve has an inside wall and a longitudinal groove on the inside wall, the flow connection being defined by the longitudinal groove.

15. The vibration damper of claim 1, wherein the valve ring comprises a friction ring and a sealing ring, the sealing ring being axially moveable relative to the friction ring and influencing the inflow of the damping medium into the valve opening.

16. The vibration damper of claim 15, wherein the sealing ring surrounds the friction ring and comprises a bottom part supporting the friction ring.

17. The vibration damper of claim 1, wherein the valve sleeve comprises a cover having a throttle opening communicating with the first working space, the valve sleeve and the piston rod defining therebetween a working section between the cover and the valve ring connected to the first working space through the throttle opening.

18. The vibration damper of claim 17, further comprising a throttle disk pre-tensioned toward the valve sleeve, the throttle opening being defined by the cover and the throttle disk.
